(19) United States
(12) Patent Application Publication
(10) Pub. No.: US 2017/0362097 A1
(43) Pub. Date: Dec. 21, 2017

(54) SYSTEM AND METHOD FOR CONTROLLING PERFORMANCE OF AQUEOUS HAZARDOUS WASTE CAPTURE

(71) Applicant: Kurion, Inc., Irvine, CA (US)

(72) Inventors: Joshua MERTZ, Richland, WA (US); Brett SIMPSON, Richland, WA (US); Whitney LAMARCHE, Richland, WA (US); Clay NULLE, Richland, WA (US); Ja-Kael LUEY, Richland, WA (US); Dustin RAE, Richland, WA (US); Ben GARRETT, Irvine, CA (US)

(73) Assignee: Kurion, Inc., Irvine, CA (US)

(21) Appl. No.: 15/621,892

(22) Filed: Jun. 13, 2017

Related U.S. Application Data
(60) Provisional application No. 62/351,190, filed on Jun. 16, 2016.

(51) Int. Cl. C02F 1/42; C02F 1/00; C02F 9/00; C02F 101/00

(52) U.S. Cl. CPC C02F 1/42; C02F 9/00; C02F 1/008; C02F 1/001; C02F 2101/006; C02F 2209/001

(57) ABSTRACT

Systems and methods are disclosed for controlling performance of a mixed ion exchange media comprising two or more media. The weighted average of a quantity of the first media having a first rate of exchange to a quantity of a second media having a second rate of exchange is determined based on predetermined requirements for the resulting mixed media. After determining the weighted average, the first and second media are mixed resulting in a mixed media having a third rate of exchange. The mixed media is introduced to an ion exchange column. Contaminated liquid is then introduced to the column creating a mass transfer zone within the column. The mixed media is generally considered optimized when it meets three conditions simultaneously: 100% safety limitation, 100% media capacity used, and effluent criteria are met.

### RELATED FILINGS

The following application claims priority to U.S. Provisional Application Ser. No. 62/351,190, filed Jun. 16, 2016 and is incorporated by reference in its entirety.

### COPYRIGHT NOTICE

Contained herein is material that is subject to copyright protection. The copyright owner has no objection to the facsimile reproduction by anyone of the patent document or the patent disclosure, as it appears in the United States Patent and Trademark Office patent file or records, but otherwise reserves all rights to the copyright whatsoever. The following notice applies to the software, screenshots and data as described below and in the drawings hereto and All Rights Reserved.

### TECHNICAL FIELD

This disclosure relates generally to ion exchange media and more specifically to control of ion exchange media performance.

### BACKGROUND

Water is frequently employed in connection with nuclear reactors for many purposes. For example, water can be used as a moderator, a reflector, a solvent, or a coolant in various types of reactors. By virtue of its proximity to the reactor core and the sources of radiation, the water employed almost invariably becomes contaminated with varying amounts of radioactive contaminants. Such contaminants comprise radioactive isotopes of strontium, thorium, iodine, plutonium, and uranium, as examples.

An industry has evolved around removing the radioactive ions from such water, either to permit reuse or to permit convenient ultimate disposal of the water. Ion exchange media may be used to remove the radioactive contaminants from the water. Generally, this involves treatment of the water with mixed ion exchange media, i.e., an ion exchange media containing a mixture of cation exchange media and anion exchange media, to remove both anions and cations. In such processes, the ion exchange media are normally discarded after use. During and after accumulation of the contaminants, proper shielding or the like must be utilized to prevent serious harm. In view of the relatively large volume occupied by the ion exchange media, the cost of materials required for proper shielding is high.

The stream which has been treated by the ion exchange media must meet strict criteria for storage or free-release into the environment. Government and International regulations require monitoring of the discharge water.

A “mixed bed” is created from one or more like-media to control performance of liquid processing via ion exchange. Like-media may comprise two or more cation media or two or more anion media. Two or more like-media may be combined to improve the total ion exchange capacity of an ion exchange column, length of the column, and rate of the mass transfer zone and control safety parameters and effluent goals. The systems and methods disclosed herein may be used for applications other than nuclear waste water processing (heavy metal waste water processing, for example).

So as to reduce the complexity and length of the Detailed Specification, Applicant(s) herein expressly incorporate(s) by reference all of the following materials identified in each paragraph below. The incorporated materials are not necessarily “prior art” and Applicant(s) expressly reserve(s) the right to swear behind any of the incorporated materials.

System and Method for Optimizing Aqueous Hazardous Waste Capture, Ser. No. 62/351,190, filed Jun. 16, 2016, which is herein incorporated by reference in its entirety.

Mobile Processing System, Ser. No. 14/748,535, filed Jun. 24, 2015, with a priority date of Jun. 24, 2014, which is herein incorporated by reference in its entirety.

Apparatus for Measuring Hexavalent Chromium in Water, Ser. No. 14/495,801 filed Sep. 24, 2014, which is herein incorporated by reference in its entirety.

Applicant(s) believe(s) that the material incorporated above is “non-essential” in accordance with 37 CFR 1.57, because it is referred to for purposes of indicating the background or illustrating the state of the art. However, if the Examiner believes that any of the above-incorporated material constitutes “essential material” within the meaning of 37 CFR 1.57(c)(1)-(3), applicant(s) will amend the specification to expressly recite the essential material that is incorporated by reference as allowed by the applicable rules.

Aspects and applications presented here are described below in the drawings and detailed description. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. §112, ¶6. Thus, the use of the words “function,” “means” or “step” in the Detailed Description or Description of the Drawings or claims is not intended to somehow indicate a desire to invoke the special provisions of 35 U.S.C. §112, ¶6, to define the systems, methods, processes, and/or apparatuses disclosed herein. To the contrary, if the provisions of 35 U.S.C. §112, ¶6 are sought to be invoked to define the embodiments, the claims will specifically and expressly state the exact phrases “means for” or “step for, and will also recite the word “function” (i.e., will state “means for performing the function of . . . ”), without also reciting in such phrases any structure, material or act in support of the function. Thus, even when the claims recite a “means for performing the function of . . . ” or “step for performing the function of . . . ”, if the claims also recite any structure, material or acts in support of that means or step, or that perform the recited function, then it is the clear intention of the inventors not to invoke the provisions of 35 U.S.C. §112, ¶6. Moreover, even if the provisions of 35 U.S.C. §112, ¶6 are invoked to define the claimed embodiments, it is intended that the embodiments not be limited only to the specific structure, material or acts that are described in the preferred embodiments, but in addition, include any and all structures, materials or acts that perform the claimed function as described in alternative embodiments or forms, or that are well known present or later-developed, equivalent structures, material or acts for performing the claimed function.

### BRIEF DESCRIPTION OF THE DRAWINGS

A more complete understanding of the systems, methods, processes, and/or apparatuses disclosed herein may be derived by referring to the detailed description when considered in connection with the following illustrative figures. In the figures, like-reference numbers refer to like-elements or acts throughout the figures.

FIG. 1 depicts a mass transfer zone in an ion exchange column.

FIG. 2 depicts a mass transfer zone as it moves down an ion exchange column with time.

FIG. 3A is a breakthrough curve showing the ratio of outlet to inlet concentration in a liquid as a function of time.

FIG. 3B is a concentration profile of solute as a function of distance along a column.

FIG. 3C depicts changes in the length of the mass transfer zone.

FIG. 4A is an example scenario at time 0 when the media in an example embodiment has not been utilized.

FIG. 4B is an example scenario at time 1 when the media in the system embodiment of FIG. 4A meets performance requirements.

FIG. 4C is an example scenario at time 1 when the media in the system embodiment of FIG. 4A does not meet performance requirements.

FIG. 4D is an example scenario at time 1 when the media in the system embodiment of FIG. 4A meets performance requirements but column 1 is underutilized.

FIG. 5A is a plot of the concentration profile of a first example ion exchange media, Media A, as a function of time.

FIG. 5B is a plot of the concentration profile of a second example ion exchange media, Media B, as a function of time.

FIG. 5C is a plot of the concentration profile of Media A, Media B, and a third ion exchange media, Media C, where Media C is a homogeneous mixture of Media A and Media B, as a function of time.

FIG. 6 is an example embodiment depicting an isotherm plot of strontium capacity of Media A, Media B, and mixed Media C.

FIG. 7A depicts an example ion exchange column with three sampling and/or sensing points.

FIG. 7B depicts an example ion exchange column with sensors for detecting radioactivity and sampling points for sampling the liquid using Inductively Coupled Plasma Mass Spectrometry (ICP-MS).

FIG. 7C depicts an example process for using sensor data to control the ion exchange rate.

FIG. 8 depicts a method for controlling performance of ion exchange media.

FIG. 9A depicts an example mixed bed ion exchange column comprising two cation exchange media.

FIG. 9B depicts an example mixed bed ion exchange column comprising two anion exchange media.

FIG. 10 depicts an example ion exchange system comprising columns running in parallel and in series.

FIG. 11 depicts a method for controlling performance of an ion exchange column.

Elements and acts in the figures are illustrated for simplicity and have not necessarily been rendered according to any particular sequence or embodiment.

### DETAILED DESCRIPTION

In the following description, and for the purposes of explanation, numerous specific details, process durations, and/or specific formula values are set forth in order to provide a thorough understanding of the various aspects of exemplary embodiments. It will be understood, however, by those skilled in the relevant arts, that the apparatus, systems, and methods herein may be practiced without these specific details, process durations, and/or specific formula values. It is to be understood that other embodiments may be utilized and structural and functional changes may be made without departing from the scope of the apparatus, systems, and methods herein. In other instances, known structures and devices are shown or discussed more generally in order to avoid obscuring the exemplary embodiments. In many cases, a description of the operation is sufficient to enable one to implement the various forms, particularly when the operation is to be implemented in software. It should be noted that there are many different and alternative configurations, devices, and technologies to which the disclosed embodiments may be applied. The full scope of the embodiments is not limited to the examples that are described below.

In the following examples of the illustrated embodiments, references are made to the accompanying drawings which form a part hereof, and in which is shown by way of illustration various embodiments in which the systems, methods, processes, and/or apparatuses disclosed herein may be practiced. It is to be understood that other embodiments may be utilized and structural and functional changes may be made without departing from the scope.

### Ion Exchange

Ion exchange involves the displacement of ions of one or more given species from an ion exchange media by ions of a different species in a liquid. Ion exchange media are often used in the treatment of liquids to remove contaminants and allow reuse or disposal of the liquid. In some embodiments, ion exchange systems may be used for one of purification, separation, and decontamination of aqueous and other ion-containing liquids or solutions.

In some embodiments, an ion exchange media can be substituted by an adsorbent or an absorbent. An adsorbent is a medium in which ion pairs or neutral atoms are trapped in on the surface of the material. An absorbent is a medium in which ion pairs or neutral atoms are trapped inside the material. Ion-exchange media, adsorbents and absorbents can all be categorized as “sorbents”.

### Ion Exchange Media and Columns

Cation exchange media give up positive ions in exchange for other positive ions from a liquid and anion exchange media give up negative ions in exchange for other negative ions from a liquid. Resins are a subset of ion exchange media, being comprised of wholly organic compounds or a mixture of organic and inorganic compounds. Mixed bed ion exchange resins typically comprise a mixture of cation exchange media and anion exchange media to exchange both cations and anions with a liquid. In some embodiments, a column may be divided into theoretical plates and each plate may comprise at least one of a first ion exchange media and a second exchange media. Theoretical plates refer to layers of media. In some embodiments, the layers are infinitely small and infinitely wide in very small particles to maximize the effectiveness of the ion exchange. In some embodiments, the layers may comprise different media or mixtures thereof.

A liquid may be continuously passed through an ion exchange column or through multiple columns until it is either free of one or more selected ions or the ion exchange media has reached capacity. Capacity of ion exchange media refers to the amount of ions the media is able to capture before no more sites are available and the media is no longer effective in removing the one or more selected ions. Ideally the ion exchange media reaches capacity at the same time the effluent has reached a target concentration (discharge criteria). In some embodiments, multiple ion exchange columns filled with the same media are arranged in series in a system. Ideally, the first column reaches capacity (100% breakthrough) while the system effluent remains at or below a given activity or concentration (discharge criteria).

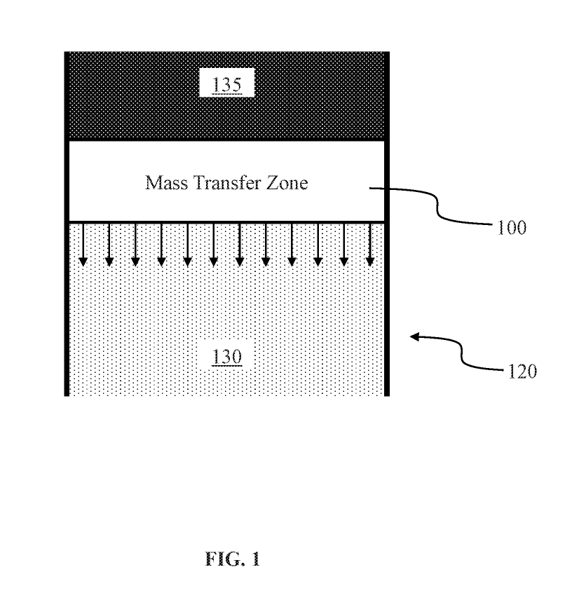

Introducing a liquid comprising one or more ions of interest to ion exchange media in an ion exchange column generates a mass transfer zone which is the portion of the column where ion exchange is occurring. FIG. 1 illustrates a mass transfer zone 100 in an ion exchange column 120. As the ion exchange media (also referred to as sorbent) becomes saturated 135 the mass transfer zone 100 moves down the column 120 through the unused media 130. The rate at which the mass transfer zone 100 moves down the column 120 is dependent on the properties of the ion exchange media and the liquid, as well as pressure and other hydraulic factors (space velocity, linear velocity). The length and rate of the mass transfer zone 100 may be altered by making adjustments to the media contained in the column 120.

In some embodiments, an ion exchange column 120 may contain one of a polymeric and mineralic insoluble media (organic resin and inorganic media), functionalized porous, gel polymer, or a mixture thereof. In some embodiments, the ion exchange media comprise at least one of zeolites, montmorillonite, clay, titanosilicates, alkali metal-metal sulfides, metal organic framework materials, and soil humus, among others. In some embodiments, ion exchange occurs between two electrolytes or between an electrolyte solution and a metal complex.

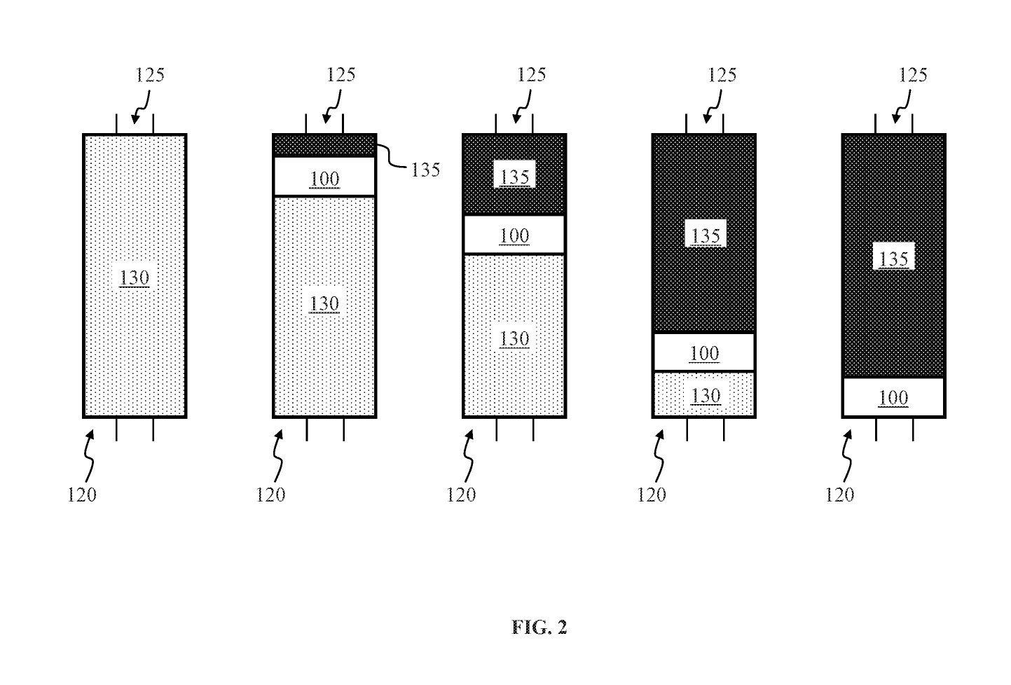

FIG. 2 illustrates the movement of the mass transfer zone 100 as liquid is introduced into the feed section 125 at the top of an ion exchange column 120. When the mass transfer zone 100 reaches the bottom of the column 120 the ion exchange media has reached capacity (saturated and no longer able to exchange ions). The common term for this occurrence is “fully loaded” or “loaded”, generally relating to loading the media with one or more ions of interest.

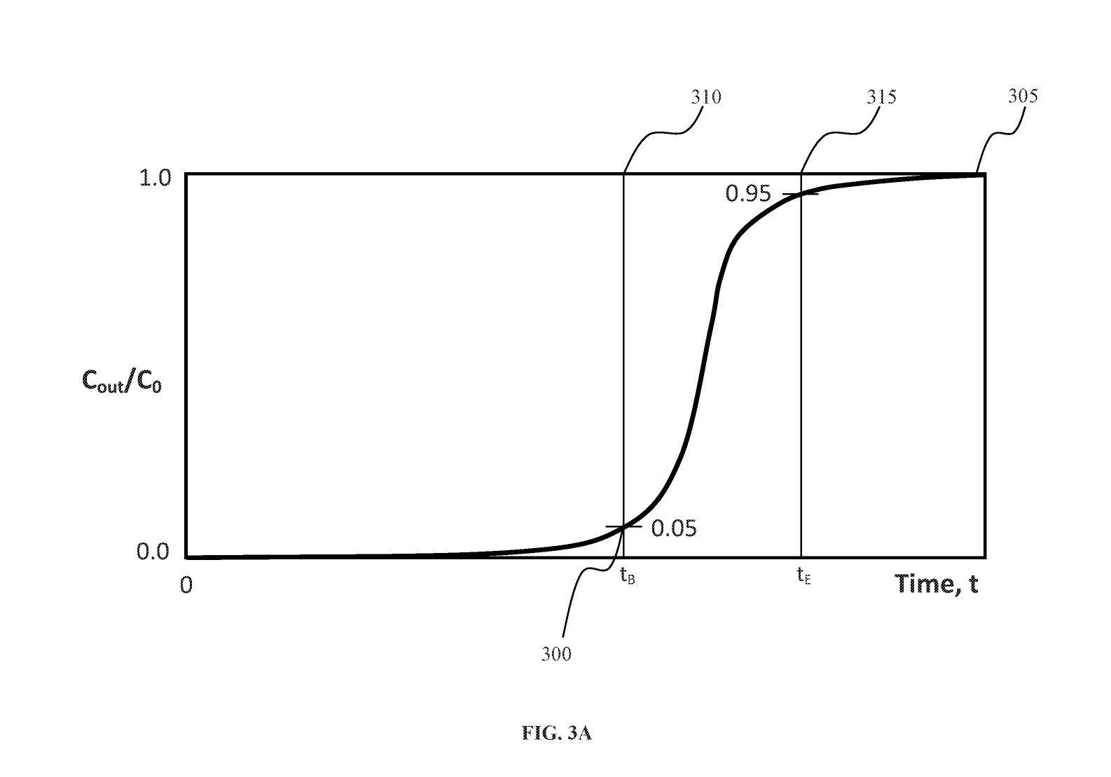

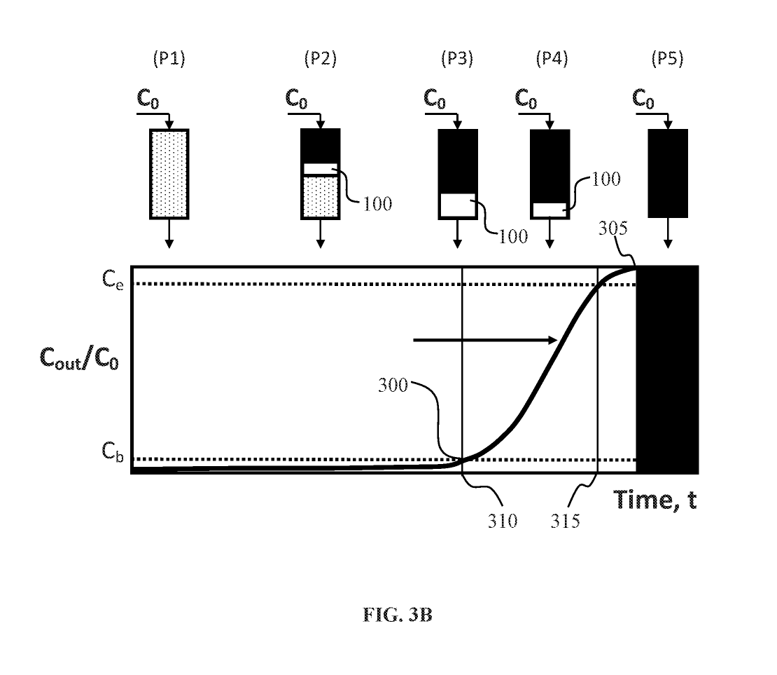

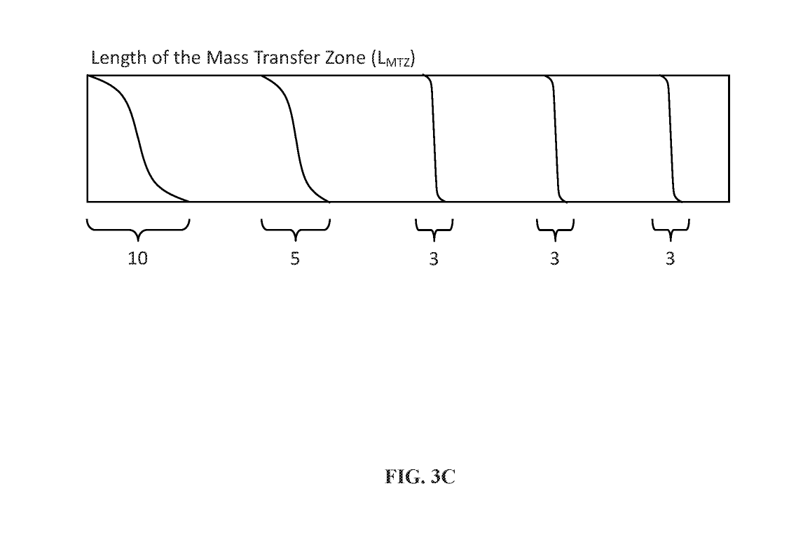

FIG. 3A is a breakthrough curve showing the ratio of outlet to inlet concentration in a liquid as a function of time. The breakthrough point or breakpoint 300 refers to the point at which most or all of the active sites have been used (the capacity of the media has been reached) and ion exchange is no longer effective. The saturation point 305 occurs when the media is fully saturated (when Cₒᵤₜ/C₀ is equal to 1). The length of the mass transfer zone can be defined at multiple concentrations (5% to 95%, for example). The length of the mass transfer zone 100 may change depending on the media and equilibrium conditions, among other things. The length of the mass transfer zone can change during the ion exchange process and depending on the bed size. Typically, the mass transfer zone gets shorter over time (the curve gets sharper). This is also dependent on where the mass transfer zone is defined (from 0.5% to 95.5% vs 0.005% to 99.995%). The time in which the leading point of the mass transfer zone reaches the end of the column is defined as time t_{B} 310. Time t_{E} 315 is the time required for the ratio of the outlet solute concentration to the inlet solute concentration in the liquid to reach 95%. The rate (speed of the mass transfer zone) depends on the concentrations, capacities of the ion exchange media, flow rate, and other hydraulic parameters, among other things.

FIG. 3B depicts the relationship between the breakthrough curve and the position of the mass transfer zone 100 as it moves down the column 120. The position of the mass transfer zone 100 is shown in different time intervals from point P1 to P5. The mass transfer zone 100 moves through the column 120 at a rate which is dependent on the media used and the properties of the influent liquid. P1 shows the column before liquid has been introduced to the media. P2 shows the column when the mass transfer zone is situated about halfway down the length of the column. P3 shows the position of the mass transfer zone 100 at the breakthrough point with an outlet concentration of C_{b}. At point P4 the ratio of the outlet solute concentration to the inlet solute concentration reaches 95% with an outlet concentration of Cₑ. Beyond this point the column approaches its saturation point 305 at P5, where the output concentration is labeled Cₛₐₜ.

The geometry and number of columns required in an ion exchange system are dependent on a number of different factors. The number of columns 120 used in the overall system depends on the particular effluent guidelines (discharge criteria) or process goals of the system, the rate at which the mass transfer zone 100 moves through the column 120, and the length of the mass transfer zone 100. Changing the rate will result in a change in the length, depth, or diameter of the column 220 and hence affects the number of columns 120 required. The overall ion exchange process may be very complicated and costly due to the amount of piping, pumps, tanks, valves, and other equipment that may be required. Developing methods to minimize the number of columns used to optimize ion exchange capacity is both effective and cost efficient.

FIG. 3C depicts example changes in the length of the mass transfer zone over time. In the depicted embodiment, at the beginning of ion exchange when the mass transfer is at or near the top of the ion exchange column, time 1, the length of the mass transfer zone is 10 units. At time 2 the length of the mass transfer zone has decreased to 5 units. At time 3 the length of the mass transfer zone has decreased to 3 units. In the depicted embodiment, equilibrium between the phases has been reached at time 3 therefore the length of the mass transfer zone stabilizes at 3 units for the remaining process time, assuming the operating conditions remain unchanged.

### Mixing Ion Exchange Media

Although potential benefits exist for the blending of media, individual components of the media often have different physical properties which may cause difficulty in obtaining a homogenous mixture. A homogenous mixture is a mixture of two or more media wherein the ratio of media taken at any point in the mixture remains the same (i.e. there are no localized areas where the media is not mixed within tolerance of the overall ratio of the mixture).

When two or more media are mixed and poured it is important that the combined media is well-blended, i.e. that the particles are uniformly distributed/dispersed throughout the mixture. If mixed and/or poured poorly or improperly one or more of radial asymmetries, axial asymmetries, pockets, striations, layers, and agglomerations can develop in the mixed media resulting in an overall reduction in the ion exchange effectiveness of the mixed media. It is also important to prevent fines (media particles that are smaller than a minimum particle size for the particular media) from generating. Large quantities of fines may cause the mixture to be out of specification, causing higher differential pressure due to reduced pore volume or loss of media under production flow conditions.

The type of mixer and the mixing time may vary depending on the media types, how many media are mixed, and the ratios of the media. In some embodiments, a rotary batch mixer may be used to blend media. In some embodiments, the media may be mixed for 1-3 minutes. Other mixer types and mixing times are contemplated. Use of a funnel during pouring may aid in maintaining the uniformity of the mixture.

### Optimization of Mixed Ion Exchange Media

Blending ion exchange media has the potential to optimize cost, performance, and shielding requirements for ion exchange systems. Optimization of mixed ion exchange media varies based on what is needed for a particular system. Optimization parameters may include one or more factors such as ion exchange rate, ion exchange capacity, media cost, longevity, effluent discharge criteria, and other factors. In some embodiments, the media is optimized when it meets three conditions simultaneously: 100% safety limitation (dose), 100% media capacity used (in a system), and effluent criteria met.

Processing parameters dependent on factors other than chemistry may create the need for variable media capacity. In some embodiments, different proportions of two or more like media (cation mixed bed or anion mixed bed) may be combined. The mixtures of these media may be used to adjust columns and vessels for safety, economic, performance, and optimization parameters. In embodiments wherein the ion exchange media is a mixture of two or more media the ion exchange capacity may relate to the ratio of the media, which may be based on the optimization parameters to target one or more specific ions. In some embodiments, a mixed ion exchange media comprises two or more media wherein the media are cation exchange media or anion exchange media. The liquid, in some embodiments, contains two or more cations or anions of interest.

In some embodiments, one or more ion exchange media having higher relative capacity may be mixed with one or more ion exchange media having lower relative capacity. The larger the amount of higher capacity ion exchange media in the mixture, the fewer columns would be needed to maintain a predetermined decontamination factor. In some embodiments, specific amounts of two or more ion exchange media may be mixed to achieve a predetermined decontamination factor. The decontamination factor refers to the ratio of radioactivity prior to and after the decontamination of the liquid.

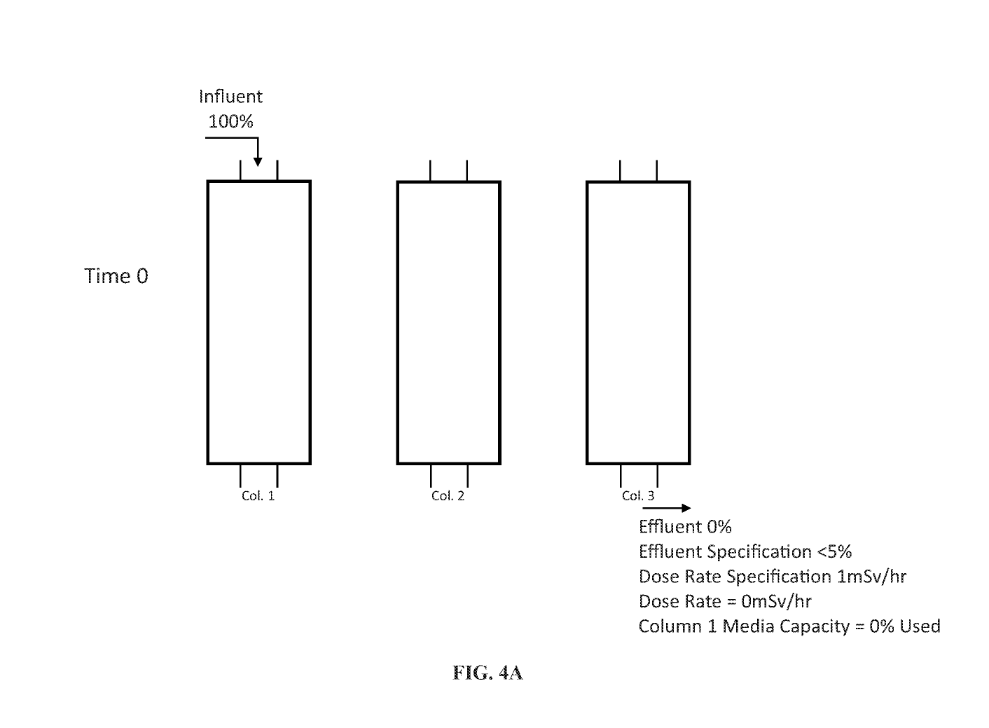

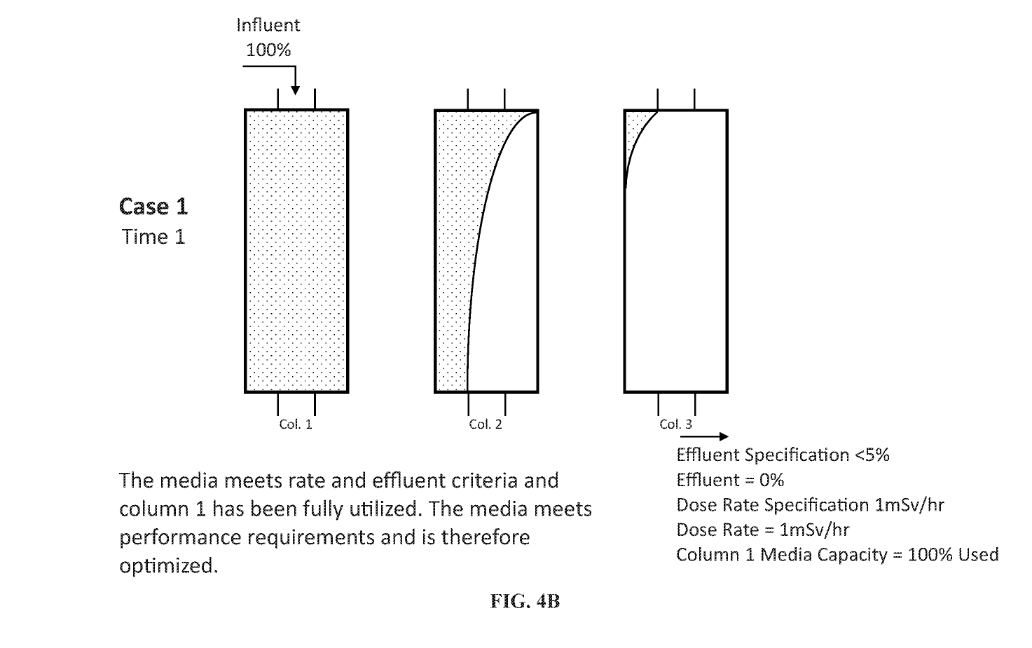

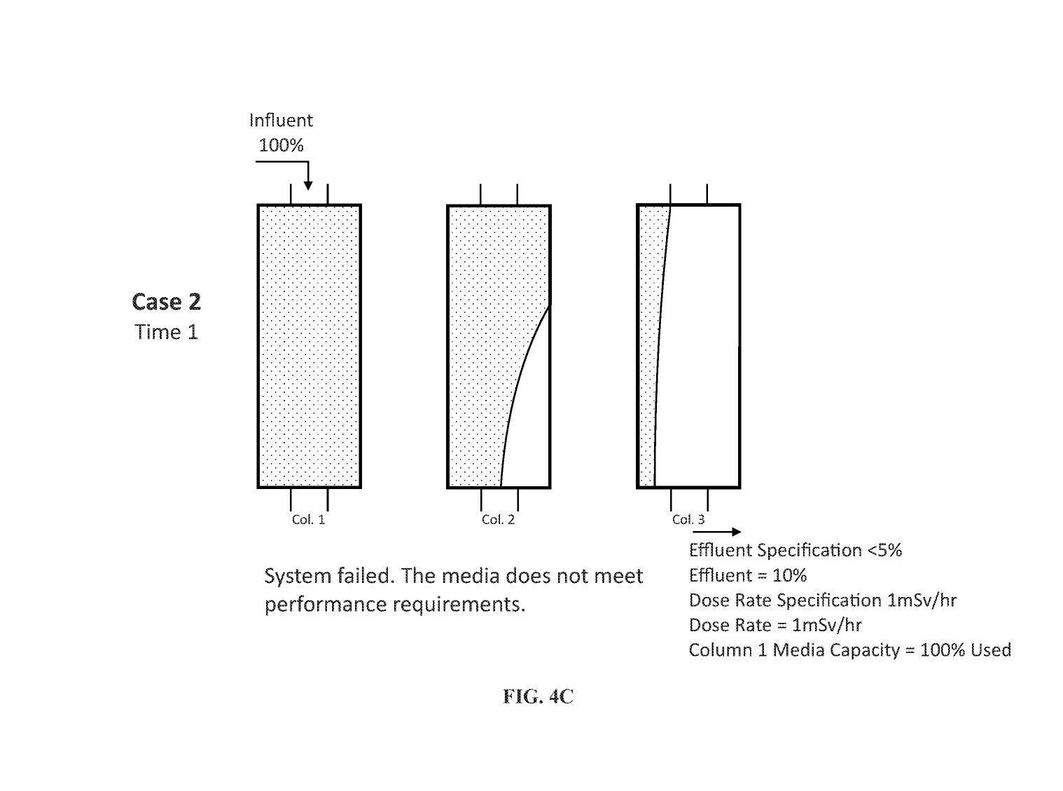

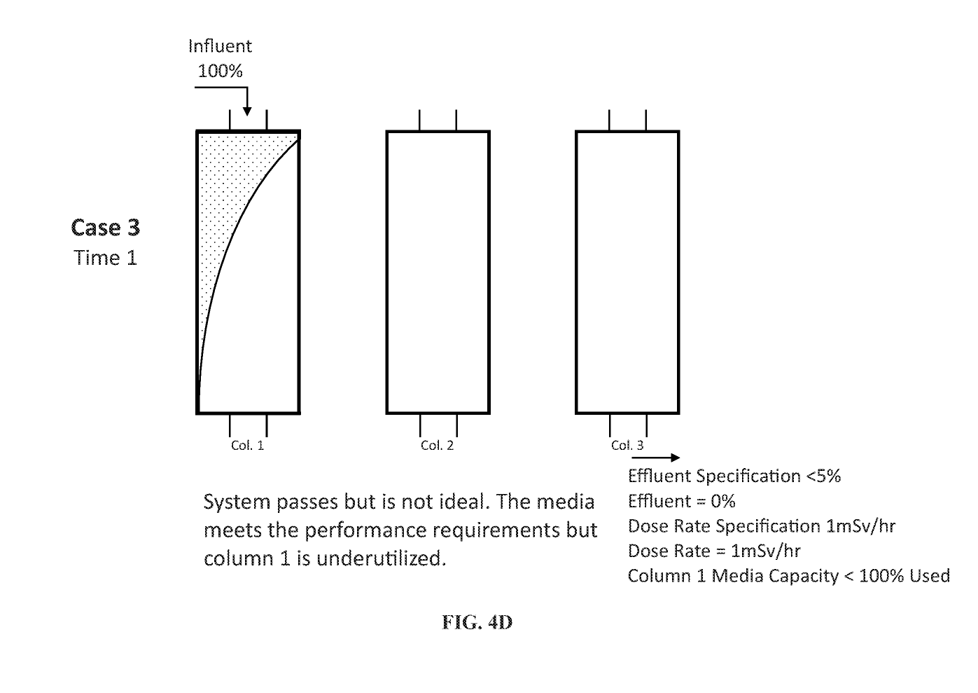

FIGS. 4A through 4D depict an example ion exchange system comprising three ion exchange columns in series. The ion exchange media in the columns may be mixed cation or mixed anion media. The number, length, and diameter of columns needed in a system is dependent on the desired effluent concentration and the rate of exchange of the mixed media. When two or more media are mixed to form mixed cation or mixed anion media, the ratio of the media may be determined to satisfy at least one of safety requirements and effluent requirements. Case 1, depicted in FIG. 4B, is an example of when the media mixture satisfies performance requirements. Cases 2 to 3, depicted in FIGS. 4C through 4D, are examples of when the media mixture fails performance requirements.

FIG. 4A depicts the ion exchange system at time 0 prior to utilization (i.e. the influent has not yet been introduced to the columns). For the depicted ion exchange system the predetermined requirements are effluent specification less than 5% and dose rate 0 mSv/hr. At time 0 there is no effluent and no media capacity has been used. FIG. 4B depicts a first example, Case 1, at time 1 where an influent has been introduced to the example system of FIG. 4A. In Case 1, the capacity of column 1 has been fully utilized, the effluent is below specification, and the dose rate meets specification. Having met these three predetermined performance criteria the system is considered to be optimized, in some embodiments.

FIG. 4C depicts a second example, Case 2, at time 1 where an influent has been introduced to the example system of FIG. 4A. In Case 2, the capacity of column 1 has been fully utilized and the dose rate meets specification; however, the effluent does not meet specification. The system has failed to meet performance requirements. FIG. 4D depicts a third example, Case 3, at time 1 where an influent has been introduced to the example system of FIG. 4A. In Case 3, the effluent and dose rates meet specification but the capacity of column 1 has been underutilized. The system passes but it is not ideal.

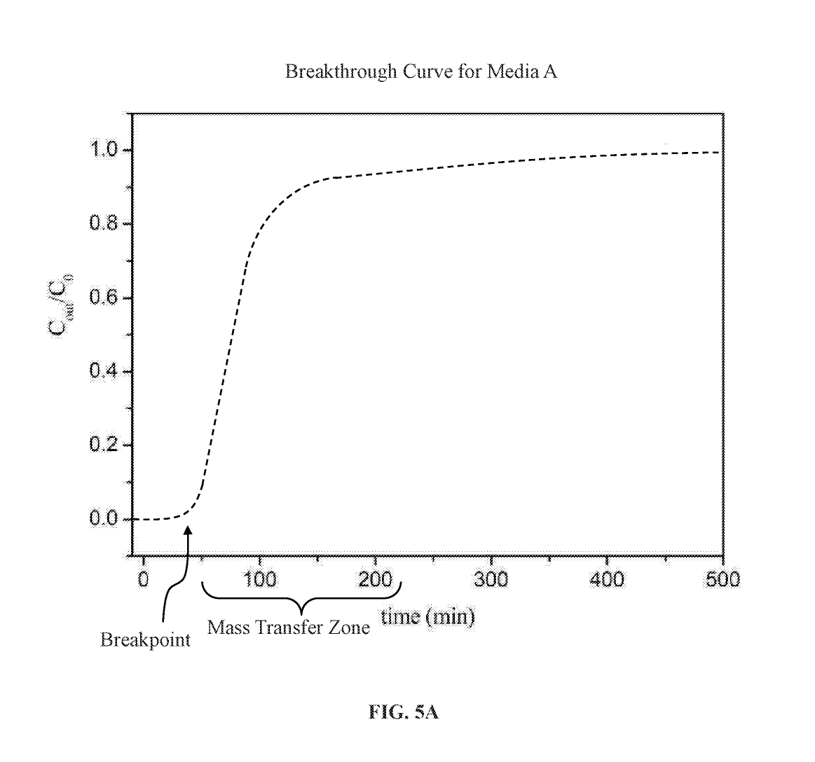

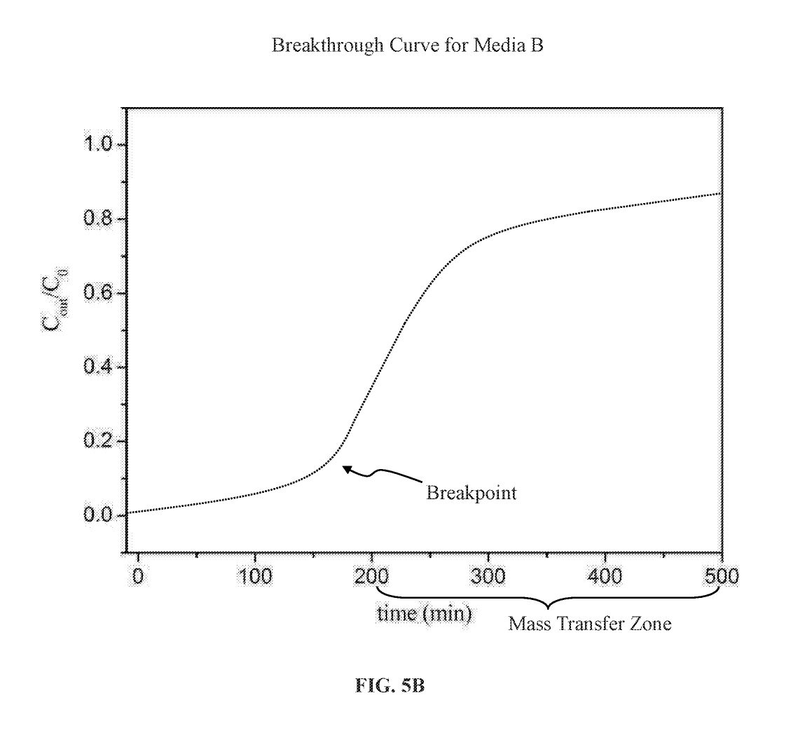

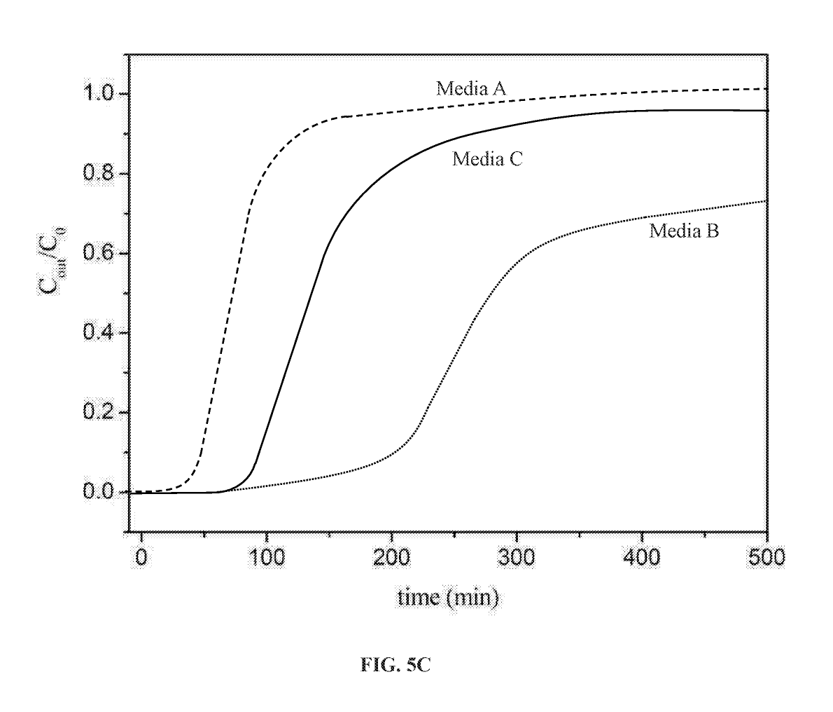

FIG. 5A is a plot of the concentration profile of a first example ion exchange media, Media A, as a function of time. FIG. 5B is a plot of the concentration profile of a second example ion exchange media, Media B, as a function of time. Both Media A and Media B have certain characteristics such as capacity, porosity, selectivity, etc. but different values thereof. For instance, in the depicted embodiments Media A has a higher capacity and is more expensive than Media B. Having a lower capacity means that Media B is not as effective at ion exchange as Media A.

Mixing a first quantity of Media A with a second quantity of Media B yields a Media C that is a significant improvement over Media B. Media C has a different capacity than Media A and Media B, which may be a weighted average of the first and second capacities which represents the total ion exchange capacity of the column. Media C is derived from the optimization of Media A and Media B to yield a more efficient ion exchange due to its higher capacity per cost. In some embodiments, the mixture Media C may not specifically yield an average capacity or proportional results.

FIG. 5C is a plot of the concentration profile of Media A, Media B, and a third ion exchange media, Media C, where Media C is a homogeneous mixture of Media A and Media B, as a function of time. In the depicted embodiment, Media C represents the third ion exchange media that is a mixture of example medias Media A (FIG. 5A) and Media B (FIG. 5B). Media C has a capacity that is lower than Media B and higher than Media A.

### Test Data

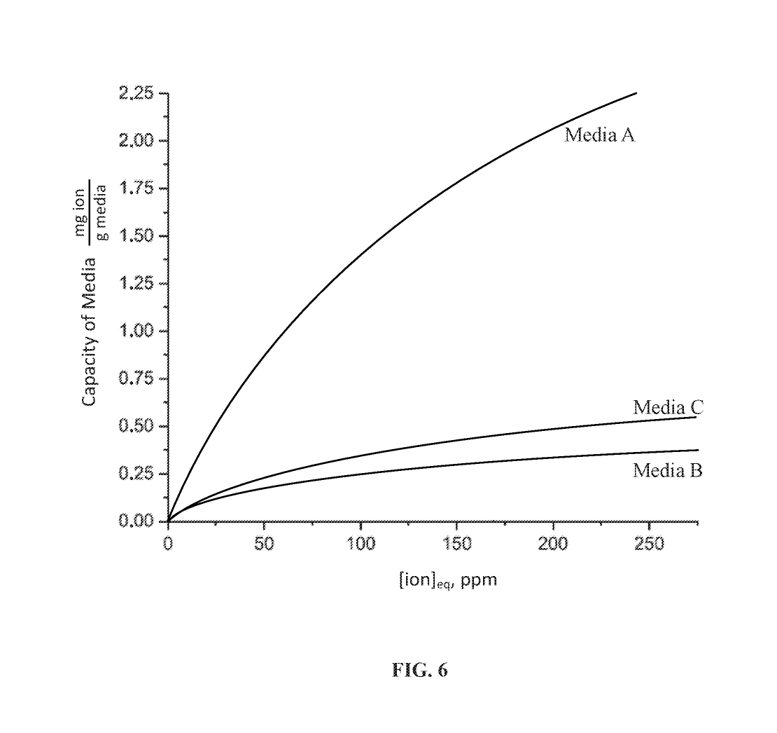

FIG. 6 depicts an example comparison of Media A (FIG. 5A), Media B (FIG. 5B), and Media C (FIG. 5C) at the same final concentration of an ion, where the final concentration is equivalent to the initial concentration for a fully utilized column. Media A may be mixed with Media B to improve the total ion exchange capacity of an ion exchange system, and as a result change the length and speed of the mass transfer zone and to ensure that safety parameters, such as dose to workers, can be met. In the depicted example embodiment the composition by mass of Media C is 10% Media A and 90% Media B. The results of Media C show that the addition of Media A to Media B results in a mixture with improved effectiveness and capacity over Media B.

### Sensors

In some embodiments, the system comprises one or more sensors and/or sampling points. The one or more sensors may be used for monitoring the ion exchange process including the effluent condition, ion concentrations, rate of exchange, temperatures, pressures, radioactivity, and time, among other things. In some embodiments, one or more radioactivity sensors may detect gamma radioactivity wherein gamma activity is gross activity. In some embodiments, one or more of the sensors may be a gamma-ray spectroscopy sensor for detecting radioactivity and/or quantitatively determining the energy spectra gamma-ray sources in the mass transfer zone. In some embodiments, one or more of the sensors may be an ultraviolet-visible spectrum or an infrared sensor for detecting the presence or signal of a cation or anion in the mass transfer zone. In some embodiments, an analytical technique that measures concentration may be applied to the system, such as inductively coupled plasma-mass spectrometry (ICP-MS). An ICP-MS can detect changes in the concentration of the effluent. In some embodiments, an ICP-MS can function in real-time or near real-time.

In some embodiments, the system may be capable of responding to the data gathered by one or more sensors to automatically adjust conditions and operating parameters of the system. For example, the system may adjust the rate of the exchange reaction by changing one or more of the influent concentrations, pressure, temperature, and flow to manage the ion exchange process in the mass transfer zone using sensor data. In some embodiments, the system is capable of making automatic adjustments in real-time.

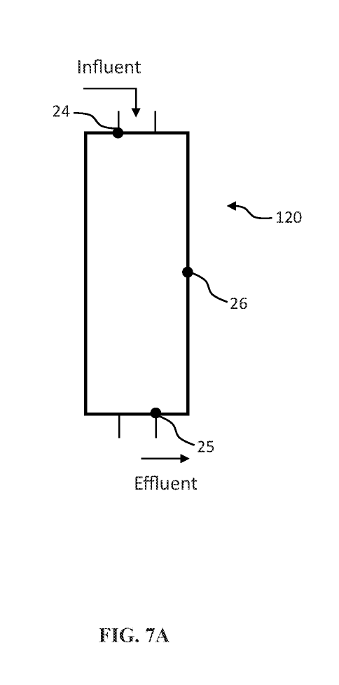

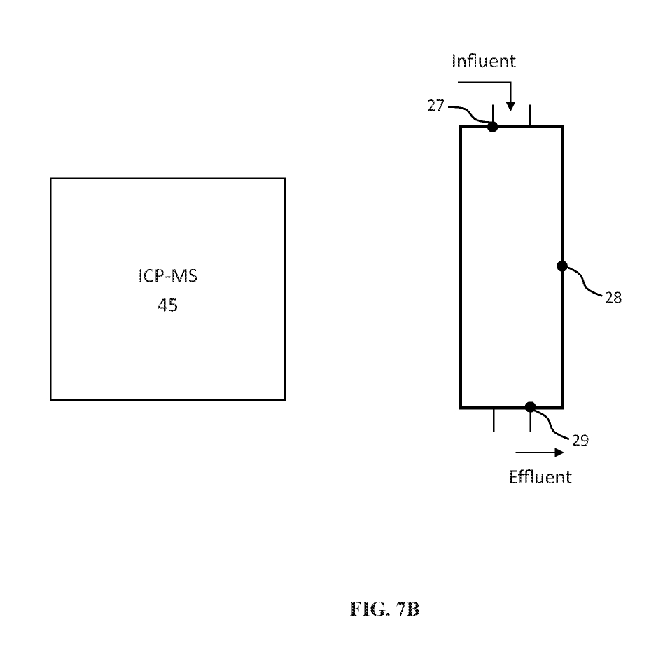

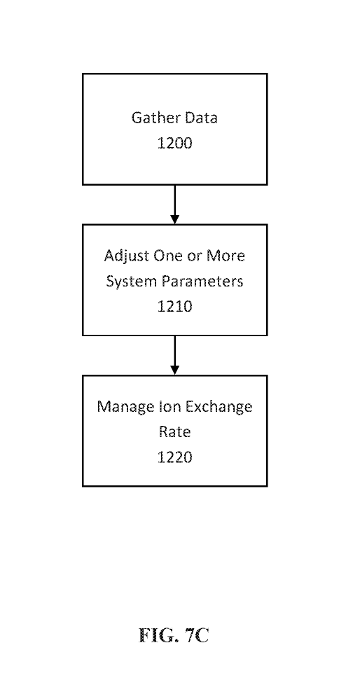

FIG. 7A depicts sensors in an example ion exchange column with sensors and sampling points. One or more columns 120 in an ion exchange system may comprise one or more sampling points and/or sensors at various locations. In the depicted embodiment, an example exchange column 120 comprises three locations 24, 25, and 26 for sampling and/or sensing. As an example embodiment, a flow sensor for determining flow of the influent, a sampling point for analyzing the influent concentrations, or collocation of the sensor and the sampling point may be placed at location 24. Location 25, in an example embodiment, may be much the same as location 24 except it may be used for measuring the effluent rather than the influent. One or more sensors may be placed at or about location 26 for determining flow rate, pressure, temperature, and radioactivity in the column 120, among other things. Locations 24, 25, and 26 and the associated sampling points and sensors described above are merely examples. Sampling points and/or sensors may be included at other locations not depicted on and/or about one or more columns 120 in an ion exchange system.

FIG. 7B depicts an example embodiment comprising sensors for sensing radioactivity and sampling points for sampling the process liquid. In the depicted embodiment sensor 28 may be used to detect radioactivity in the system including gamma activity. In some embodiments, gamma activity is gross activity. In some embodiments, the radiation sensor 28 is configured to quantitatively determine the energy spectra gamma ray sources in the mass transfer zone. Sampling points 27 and 29 may be used for gathering samples of the process liquid to be analyzed by equipment, such as an Inductively Coupled Plasma-Mass Spectrometer (ICP-MS) 45, to determine the concentration of ions.

FIG. 7C depicts an example process for using sensor data to control the ion exchange rate. One or more sensors may gather data in the system such as flow rate, activity, temperature, pressure, and ion concentration 1200. If the reaction rate is proceeding too quickly or too slowly the rate may be adjusted by changing one or more system parameters 1210, such as flow rate, temperature, pressure, and influent concentration. The ion exchange rate may be managed 1220 by performing steps 1200 and 1210 continuously, periodically, or intermittently as required by the particular ion exchange system.

### Example Embodiments

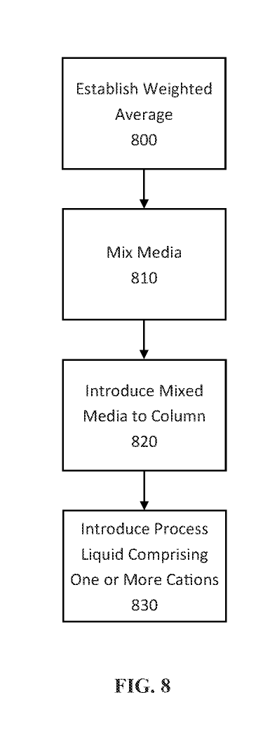

Two or more ion exchange media may be mixed to control performance one or more parameters including the ion exchange rate in a resulting mixed media. In some embodiments, improved performance of an ion exchange rate is achieved by mixing two or more media having different capacities and ion exchange rates together. FIG. 8 depicts an example method for controlling performance of a mixed ion exchange media comprising two media having different characteristics. First, the weighted average of a quantity of the first media to a quantity of a second media is established 800 based on predetermined requirements for the resulting mixed media. The first and second media are then mixed 810 resulting in a mixed media having different characteristics from the first and second media.

As an example, a system comprises a one liter column and needs to achieve a dose rate of 1 mSv/hr. The column would have an equivalent capacity of 20 mg/L when the activity reaches 1 mSv/hr. An example Media Q has a capacity of 10 mg/L and an example Media R has a capacity of 100 mg/L. To meet dose requirements a mixture of Media Q and Media R needs to have a capacity of 20 mg/L. Equation 1 may be used to determine how much of each media is required in the mixture.

$$10 \frac{mg}{L} ( x ) + 100 \frac{mg}{L} ( y ) = 20 \frac{mg}{L} \qquad ( 1 )$$

where x is the percent of Media Q needed and y is the percent of Media R needed.

Equation 2 shows that 100% of the mixed media is composed of Media Q and Media R.

x+y=1 (2)

Solving Equation 2 for x yields:

x=1−y (3)

Equation 3 may be used to substitute for x in Equation 1 to solve for y:

$$\begin{matrix}10 ( 1 - y ) + 100 ( y ) = 20 & ( 4 ) \\ ( 1 - y ) + 10 ( y ) = 2 & ( 5 ) \\ 1 + 9 y = 2 & ( 6 ) \\ y = \frac{1}{9} = 0.111 = 11 \% & ( 7 )\end{matrix}$$

### Solving for x:

x=1−0.111=0.889=89% (8)

The example mixed media therefore needs to be 11% Media Y and 89% Media Q to meet dosage requirements.

The mixed media is introduced to an ion exchange column 820. Then a contaminated liquid is introduced to the column 830 where the contaminated liquid, in the example embodiment, comprises two cations. The introduction of the contaminated liquid to the mixed media creates a mass transfer zone within the column. The mass transfer zone moves through the column at the rate of exchange of the mixed media. The length, diameter, and number of columns is dependent on the exchange rate of the mixed media.

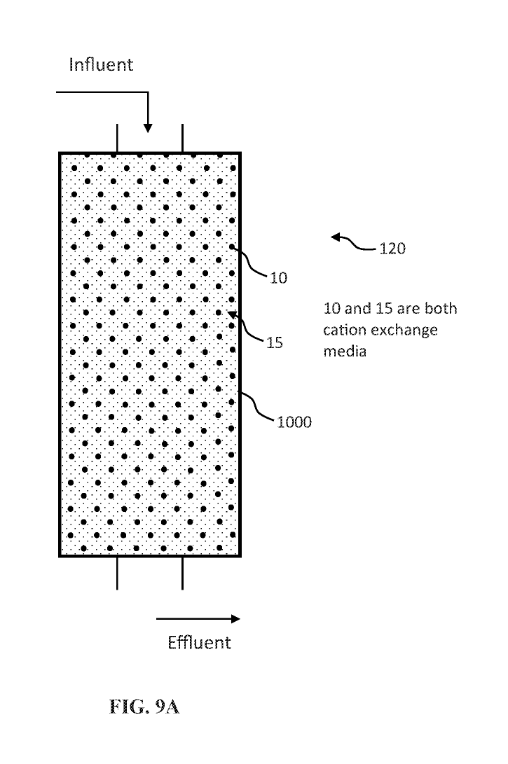

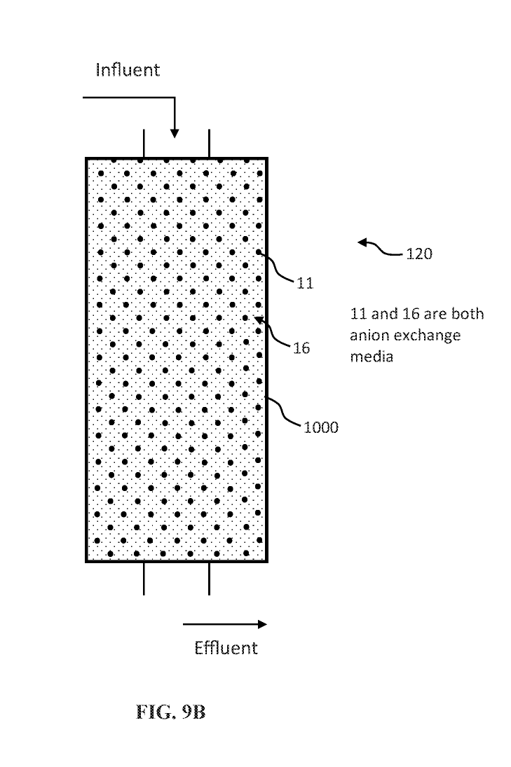

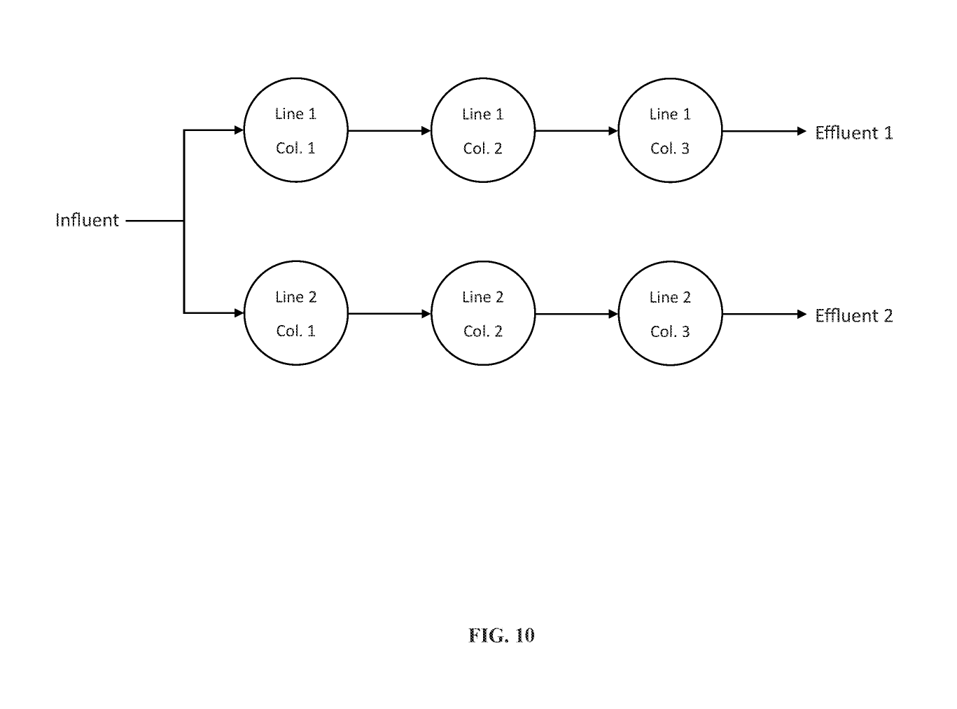

FIGS. 9A and 9B depict example mixed bed ion exchange columns comprising two media. FIG. 9A depicts an example mixed bed ion exchange column 120 comprising two cation exchange media 10 and 15. FIG. 9B depicts an example mixed bed ion exchange column 120 comprising two anion exchange media 11 and 16. In the depicted embodiments the influent is a contaminated liquid comprising two ions of interest (two cations in FIG. 9A and two anions in FIG. 9B). A mixture of two or more media allows for simultaneous exchange of two or more ions with equal or different attraction strengths. In some embodiments, such as the one depicted in FIG. 10, two or more ion exchange columns may be configured to run in series and/or parallel.

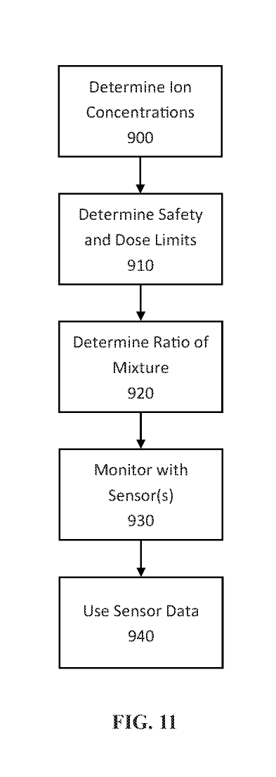

FIG. 11 depicts an example method for controlling performance of an ion exchange column comprising two ion exchange media. In some embodiments, a mixed bed ion exchange column is configured to operate by the method depicted in FIG. 11. First, the concentrations of the ions in the liquid are determined 900. Safety and dose limitations of the mixed bed ion exchange column when fully loaded are determined 910. A ratio of a first ion exchange media to a second ion exchange media is then determined 920, wherein the ratio is determined based on an optimized exchange of the mixed media to target specific ions, and wherein the ratio represents the total ion exchange capacity of the mixed bed ion exchange column. The mixed bed ion exchange column is monitored with one or more sensors 930 wherein the sensors detect at least one of activity and ion concentration for the contaminated liquid. The sensor data, including at least one of activity and ion concentration in the contaminated liquid is used 940 to determine size of the ion exchange column by at least one of determining the speed of the mass transfer zone and the length of the mass transfer zone.

In some embodiments an ion exchange system comprises one or more sensors for gathering data related to one or more of ion concentrations in the liquid, safety and dosage limitations of the system when fully loaded, temperature, pressure, flow rates, rate of exchange, and length and/or position of the mass transfer zone among other things.

It should be clear that the above is merely one example embodiment. Any one or more aspects of the described embodiment may be incorporated in other embodiments not expressly disclosed herein.

For the sake of convenience, the operations are described as various interconnected functional blocks or distinct software modules. This is not necessary, however, and there may be cases where these functional blocks or modules are equivalently aggregated into a single logic device, program or operation with unclear boundaries. In any event, the functional blocks and software modules or described features can be implemented by themselves, or in combination with other operations in either hardware or software.

Having described and illustrated the principles of the systems, methods, processes, and/or apparatuses disclosed herein in a preferred embodiment thereof, it should be apparent that the systems, methods, processes, and/or apparatuses may be modified in arrangement and detail without departing from such principles. Claim is made to all modifications and variation coming within the spirit and scope of the following claims.

1. A method for controlling performance of at least one of an ion exchange media and ion exchange system, comprising:
determining a weighted average of a first quantity of a first ion exchange media having a first rate of exchange and a first capacity to a second quantity of a second ion exchange media having a second rate of exchange and a second capacity, wherein the weighted average is a third rate of exchange that is different than the first rate of exchange and the second rate of exchange,
responsive to determining the weighted average, mix the first quantity with the second quantity generating a third quantity of a mixed ion exchange media having the third rate of exchange,
introducing the mixed ion exchange media into a column, and
introducing a contaminated liquid into the column, wherein the introduction of the contaminated liquid to the mixed ion exchange media creates a mass transfer zone within the column, wherein the mass transfer zone moves through the column at the third rate of exchange.

2. The method of claim 1, wherein the contaminated liquid comprises one or more cations.

3. The method of claim 1, wherein the first and second ion exchange media are cation exchange media.

4. The method of claim 1, wherein the first and second ion exchange media are anion exchange media.

5. The method of claim 1, wherein the weighted average of the first and second capacities is a total ion exchange capacity of the column.

6. The method of claim 1, further comprising monitoring the column with a sensor, wherein the sensor detects at least one of activity and ion concentration for the contaminated liquid.

7. The method of claim 6, wherein responsive to detecting the at least one of activity and ion concentration with the sensor, adjust a rate of reaction between the contaminated liquid and the mixed ion exchange media by changing at least one of influent concentration of the contaminated liquid, pressure in the column, flow in the column, and temperature in the column.

8. The method of claim 1, further comprising using a number of columns based on the third rate of exchange and a desired output concentration.

9. The method of claim 1, wherein the ratio of the first media and the ratio of the second media are determined based on a selected dose rate of the column.

10. The method of claim 1, wherein the ratio of the first media and the ratio of the second media are based on effluent requirements at a given time.

11. The method of claim 1, wherein the first and second quantities are selected based on a desired rate of exchange.

12. The method of claim 1, further comprising introducing the mixed ion exchange media and contaminated liquid into multiple columns connected in at least one of series and parallel.

13. The method of claim 1, wherein the first rate of exchange is less than the second rate of exchange.

14. A system for treatment of a contaminated liquid, comprising;
a contaminated liquid, wherein the contaminated liquid comprises at least a first cation and a second cation;
a mixed bed ion exchange column comprising a mixture of a first cation exchange media and a second cation exchange media, wherein the mixture allows for the simultaneous exchange of the first and second cation, wherein the mixture further allows for the simultaneous exchange of the first cation with equal and different attraction strengths, and wherein the mixed bed ion exchange column is configured to operate by:
determining concentrations of the first and second cations in the contaminated liquid,
determining safety and dose limitations of the mixed bed ion exchange column when fully loaded,
determining a ratio of the first ion exchange media to the second ion exchange media, wherein the ratio is based on a predetermined exchange of the mixed media to target specific ions, and wherein the ratio represents the total ion exchange capacity of the mixed bed ion exchange column,
monitoring the mixed bed ion exchange column with a sensor, wherein the sensor detects at least one of activity and ion concentration for the contaminated liquid;
using the at least one of activity and ion concentration in the contaminated liquid to determine size of the ion exchange column by at least one of determining the speed of the mass transfer zone and the length of the mass transfer zone.

15. The system of claim 14, wherein a sensor is used to detect at least one of activity and ion concentration and wherein a rate of reaction is adjusted by changing at least one of concentration of the first and second cations, pressure, flow, and temperature to manage ion exchange rate.

16. The system of claim 14, wherein the ion exchange column is for at least one of purification, separation, and decontamination of aqueous and other ion-containing liquids.

17. The system of claim 14, wherein the first and second cation exchange media comprise of at least one of functionalized porous sorbents and gel polymer ion exchange sorbents.

18. The system of claim 14, wherein the first and second cation exchange media are further comprised of at least one of zeolites, montmorillonite, clay, titanosilicates, alkali metal-metal sulfides, metal organic framework materials, and soil humus.

19. The system of claim 14, wherein ion exchange is at least one of an exchange of ions between two electrolytes and between an electrolyte solution and a metal complex.

20. The system of claim 15, wherein the sensor detects radioactivity.

21. The system of claim 15, wherein the sensor is a gamma sensor and detects gamma radioactivity, and wherein the gamma activity is gross activity.

22. The system of claim 15, wherein the sensor is a gamma-ray spectroscopy sensor configured to quantitatively determine the energy spectra gamma-ray sources in the mass transfer zone.

23. The system of claim 15, where the sensor is an inductively coupled plasma mass spectrometer for measuring the concentration of at least one of the contaminated liquid and effluent.

24. The system of claim 14, wherein the first and second cation exchange media is at least one of polymeric and mineralic insoluble media.
